(19) United States
(12) Patent Application Publication
(10) Pub. No.: US 2024/0259102 A1
(43) Pub. Date: Aug. 1, 2024

(54) Optical Transceiver and Controller Thereof

(71) Applicant: Nippon Telegraph and Telephone Corporation, Tokyo (JP)

(72) Inventor: Toshihiro Ito, Musashino-shi, Tokyo (JP)

(21) Appl. No.: 18/560,781

(22) PCT Filed: Jun. 21, 2021
(86) PCT No.: PCT/JP2021/023486

§ 371 Date: Nov. 14, 2023

(51) Int. Cl. H04B 10/40

(52) U.S. Cl. CPC H04B 10/40

(57) ABSTRACT

The present disclosure provides an optical transmitter/receiver which is easy to configure to use minimum power consumption. An optical transmitter/receiver which transmits and receives an optical signal in which information is encoded in a phase and a light intensity includes: an optical receiver having a light receiving element configured to receive the optical signal, in which a dependence of an amount of noise generated in the optical receiver in accordance with operating conditions of the optical receiver, photosensitivity of the light receiving element, and power consumption with respect to setting parameters is output to a control device of the optical transmitter/receiver.

### TECHNICAL FIELD

The present invention relates to an optical transmitter/receiver and a control device thereof.

### BACKGROUND ART

With the constant development and spread of various applications such as social media and video distribution, and the construction of data centers and 5th generation mobile communication system (5G) infrastructure, the Internet all over the world continues to expand and the capacity of optical communication, which serves as the backbone line is also increasing.

Along with this, large-capacity transmission is possible not only for long-distance communication such as between distant cities, but also for medium-distance communication and short-distance communication such as in data centers and there is a need for high-speed optical transmitters/receivers which are inexpensive relative to capacity.

In the related art, in short-distance communication, direct intensity modulation type optical transmitters/receivers having a simple structure have been used for the transmitter/receiver. However, with the above as the background, a digital coherent optical transmission technique which greatly increases transmission capacity has also been gradually introduced (see, for example, NPL 1). Optical transmitters/receivers used for digital coherent optical transmission include a digital signal processor, an optical modulator, and a local light source and transmitting and receiving signal light by modulating and demodulating both the phase and light intensity can greatly increase the transmission capacity. Optical transmitters/receivers which transmit and receive digital coherent light can realize a communication capacity of 400 Gbps or more per wavelength and can realize a reduction in cost relative to transmission capacity.

In this technique in the related art, an optical transmitter (TX) uses an optical modulator to modulate a phase of light emitted from an integrable tunable laser assembly (ITLA) and then polarization-multiplexes it for transmission. The optical transmitter (TX) modulates the phase and the intensity of the light emitted from the ITLA and may further polarization-multiplex and transmit the light. An optical receiver (RX) includes a dual polarization optical hybrid (DPOH), a photodiode, a transimpedance amplifier, and an integrated tunable laser array. The DPOH receives the local light from the ITLA and the received signal light, allows these lights to interfere, and outputs them. The photodiode receives the light output from the DPOH, photoelectrically converts it, and outputs an electrical signal. A transimpedance amplifier amplifies the electrical signal output from the photodiode. The electrical signal amplified by the transimpedance amplifier is digitally processed by a digital signal processor (DSP) located after the optical receiver (RX) and dual polarization 16-level quadrature amplitude modulation (DP-16QAM) and dual polarization quadrature phase shift keying (DP-QPSK) transmission signals are restored.

The optical receiver (RX) which transmits and receives digital coherent light has a built-in local light source and requires a complicated device configuration for signal processing by an electrical DSP. On the other hand, since the phase of light is used in addition to the amplitude, the transmission capacity per wavelength can be increased and various imperfections such as dispersion can be handled by digital processing. Thus, particularly, it has been widely used for long-distance optical communication.

In recent years, a transmission rate has been increasing and one unit can transmit 100 Gb/s or 400 Gb/s. Furthermore, optical transmitters/receivers (TX/RX) in which an ultra-compact optical transmitter (TX) and an optical receiver (RX) using silicon photonics are disposed adjacently has been used.

For an optical network which can be configured using such an optical transmitter/receiver, a configuration for use with a one-to-one transmitter/receiver pair and a configuration in which a combination of an optical transmitter/receiver (TX/RX) changes dynamically such as by using a reconfigurable optical add/drop multiplexer (ROADM) are also used. In the optical transmitters/receivers in the related art used herein, it is assumed that the performance of each transmitter/receiver is constant and the power is also constant.

### CITATION LIST

### Non Patent Literature

[NPL 1] Yutaka Miyamoto and the like, “Ultra-Large-Capacity Digital Coherent Optical Transmission Technology”, NTT Technical Review, 2011, vol. 23, No. 3, pp. 13 to 18

### SUMMARY OF INVENTION

In such a background, optical receivers and optical transmitters in the related art have the following problems. That is to say, the performance was constant and any combination of the optical receiver and the optical transmitter basically always maintained a constant transmission capability. Even if a distance between two optical receivers and an optical transmitter set as a communication pair at a certain point is short and there is sufficient transmission capacity, since it is difficult to calculate the performance margin in advance, they were used as they are.

Optical receivers and optical transmitters which transmit and receive coherent light have driver ICs, transimpedance amplifiers, local light sources, and digital signal processors (DSPs) as parts in which power consumption is required and each element consumes electric power. There is room to reduce power consumption such as according to driver IC output current and DSP equalizer algorithm settings. With optical receivers and optical transmitters in the related art, it is difficult to accurately predict how much margin there is in performance until they are actually put into operation, and as a result, it has been difficult to calculate how much room there is to lower the power of the multiple elements of the optical receiver and optical transmitter. For this reason, the optical receiver and optical transmitter in the related art need to be set to use power with a large margin and it has been difficult to efficiently reduce the power and use them in accordance with the situation.

The present disclosure was made in response to such problems and facilitates configuring an optical transmitter/receiver to use a minimum amount of power in accordance with a combination of communication pairs of optical transmitters/receivers, individual performances of optical transmitters/receivers, environmental conditions, and the like.

In order to achieve such an object, an embodiment of the present invention is an optical transmitter/receiver which transmits and receives an optical signal in which information is encoded in a phase and a light intensity including: an optical receiver having a light receiving element configured to receive the optical signal, in which a dependence of an amount of noise generated in the optical receiver in accordance with operating conditions of the optical receiver, photosensitivity of the light receiving element, and power consumption with respect to setting parameters is output to a control device of the optical transmitter/receiver. Another embodiment of the present invention is an optical transmitter/receiver which transmits and receives an optical signal in which information is encoded in a phase and a light intensity including: an optical transmitter having a modulator configured to generate the optical signal, in which an optical intensity according to a current input to the modulator, a signal-to-noise (SN) ratio of the optical transmitter, and the dependence of power consumption with respect to setting parameters are to a control device of the optical transmitter/receiver in accordance with operating conditions of the optical transmitter such as a power supply voltage, a gain, and a temperature. Yet another embodiment of the present invention is a control device for the above optical transmitter/receiver which calculates the setting parameters of the optical transmitter/receiver on the basis of the information output from the optical transmitter/receiver, and transmits the setting parameters to the optical transmitter/receiver.

According to one embodiment of the present invention, it becomes easy to set an optical receiver or an optical transmitter to use a minimum necessary power consumption in accordance with a combination of communication pairs.

### BRIEF DESCRIPTION OF DRAWINGS

FIG. 1 is a diagram for explaining an optical transmitter/receiver and a control device in the related art.

FIG. 2 is a diagram for explaining an optical transmitter/receiver and a control device according to an embodiment of the present invention.

FIG. 3 is a schematic configuration diagram of an optical transmitter/receiver according to the embodiment of the present invention.

FIG. 4 is a diagram for explaining an operation of an optical transmitter/receiver and a control device according to the embodiment of the present invention.

### DESCRIPTION OF EMBODIMENTS

An embodiment of the present invention will be described in detail below with reference to the drawings. The same or similar reference numerals indicate the same or similar elements and redundant description thereof may be omitted. Before the embodiment of the present invention is described, an optical transmitter/receiver and a control device in the related art will be described.

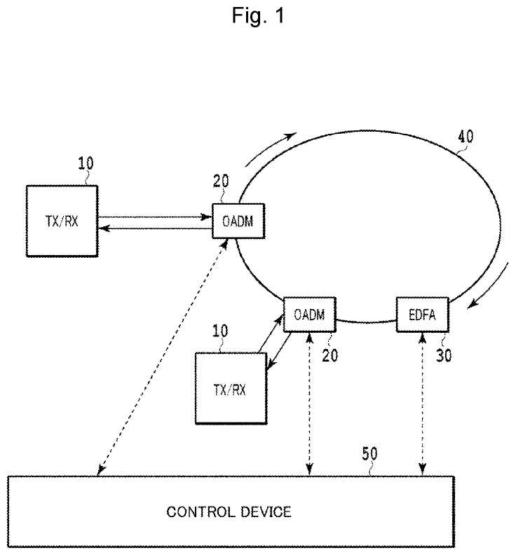

FIG. 1 is a diagram illustrating an optical transmitter/receiver and a control device in the related art. As shown in FIG. 1, a communication system includes two optical transmitters/receivers (TX/RX) 10 configured to form a communication pair, a switching device 20 such as an optical add/drop multiplexer (OADM) connected in a ring shape with an optical fiber 40, and an amplifier 30 such as an erbium-doped fiber amplifier (EDFA). The two TX/RX's 10 are connected with the OADM 20, respectively. The OADM 20 and the EDFA 30 are connected to the control device 50. The OADM 20 sets a communication path between the two TX/RX 10 on the basis of the control signal from the control device 50.

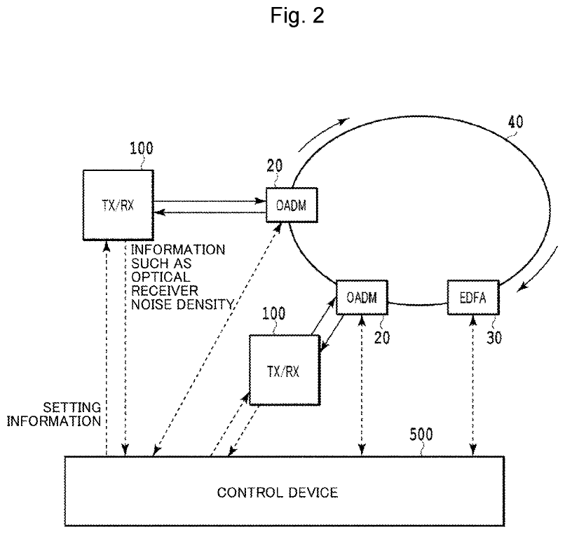

FIG. 2 shows an optical network including an optical transmitter/receiver (TX/RX) 100 and a control device 500 according to a first embodiment of the present invention. This network is composed of a plurality of TX/RX 100, switching devices such as OADMs 20, a control device 500 which controls the TX/RX 100 and the OADMs 20, and an optical fiber 40 which connects the OADMs 20. In this network, the communication path and the combination of the optical transmitters/receivers 100 at both ends of the path dynamically change in accordance with the communication needs. Path switching is determined using the control device 500 and the switching itself is performed using the switching device 20 such as the OADM included in the network.

The control device 500 determines a necessary communication path at that time on the basis of information from the outside such as an external communication device or a computer device operated by an operator, but the path is not necessarily unique. The control device 500 also determines some setting parameters for the optical transmitter/receiver 100.

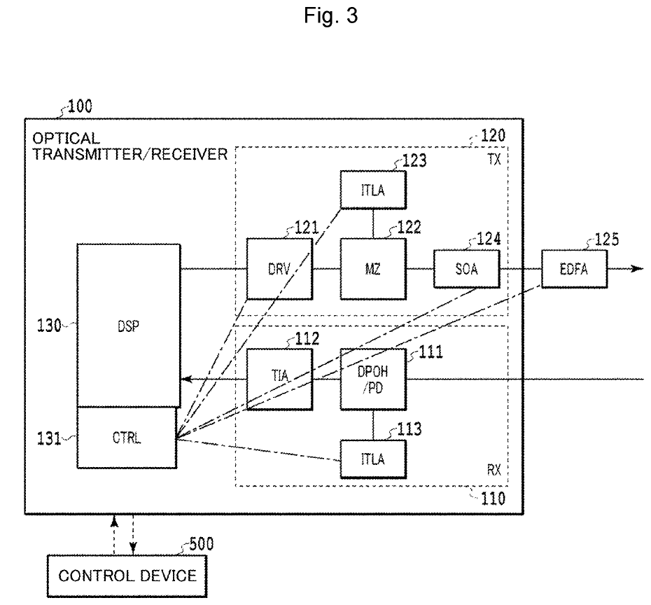

FIG. 3 shows the configuration of the optical transmitter/receiver (TX/RX) 100 of this embodiment. The TX/RX 100 has an optical receiver (RX) 110, an optical transmitter (TX) 120, a digital signal processor (DSP) 130, and a control device (CTRL) 131.

The RX 110 includes optical circuits 111 such as a DPOH and a PD, a transimpedance amplifier (TIA) 112, and a local light source (ITLA) 113. The TX 120 includes a modulator driver (DRV) 121, an optical Mach-Zehnder (MZ) modulator 122, and a local light source (ITLA) 123. The TX 120 may include optical amplifiers such as an SOA 124 and an EDFA 125. The digital signal processor (DSP) of the TX/RX 100 is configured to exchange signals with the optical receiver 110 and the optical transmitter 120. The CTRL 131 is connected to the DSP 130, the control device 500, the optical receiver 110 and the optical transmitter 120. The CTRL 131 controls components of the optical receiver 110 and the optical transmitter 120 on the basis of the control signals from the control device 500. Instead of using the two local light sources ITLA 113 and ITLA 123, light from one light source ITLA may be split into two local light and used.

The TX/RX 100 has adjustable parameters such as an output current of the modulator driver 121 provided to the optical MZ modulator 122, an optical intensity of the local light sources 113 and 123, an amplification factor of the optical amplifiers 124 and 125, and a length of an electric filter (not shown) in the DSP 130. These parameters change the power consumption in each element through adjustment. Here, although the output current of the modulator driver 121 refers to a drive current in a case in which an output part of the modulator driver 121 has no or a small resistance inside the driver such as an open collector configuration and is configured to drive the built-in resistance of the optical MZ modulator 122, any device which adjusts the voltage or the current of the modulator driver 121 itself may be used, including a case in which an open collector configuration is not used. The dependence of SN with respect to adjustment parameters such as an output current is output to the control device 500. These pieces of data may be data obtained in advance at the stage of testing or designing a part or all of the TX/RX 100 and stored in the internal memory of the TX/RX 100.

In addition, the control unit 131 of the TX/RX 100 outputs, as data, the environmental conditions at a point in time, that is, a dependence of a power supply voltage, a gain, a temperature, a wavelength, and a thermal noise density of the TIA 112 and a shot noise density (frequency density) of the ITLA 113 converted on the basis of these with respect to a current to the control device 500. This data is data acquired in advance at the stage of testing or designing a part or all of the TX/RX 100 and stored in the internal memory of the TX/RX 100.

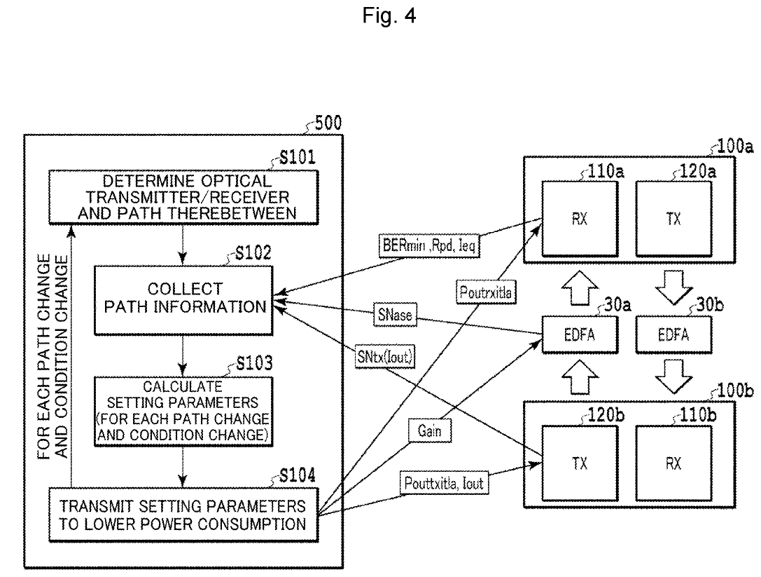

Operations of the optical transmitter/receiver 100 and the control device 500 of the embodiment will be described with reference to FIG. 4. In FIG. 4, two optical transmitters/receivers 100a and 100b constitute a communication pair. FIG. 4 shows an optical transmitter (TX) 120a and an optical receiver (RX) 110b which constitute the optical transmitter/receiver 100a, the TX 120b and the RX 100b constituting the optical transmitter/receiver 100b, the TX/RX 100b, and an EDFA 30a disposed in a path between the TX 120b and the RX 110a and an EDFA 30b disposed in a path between the TX 120a and the RX 110b. The control device 500 is communicably connected to the optical transmitters/receivers 100a and 100b and the EDFAs 30a and 30b.

In Step S101, the control device 500 determines the path between the two optical transmitters/receivers (TX/RX) 100a and 100b configured to form a communication pair and the TX/RX 100a and TX/RX 100b. The method of determining the TX/RX 100a, the TX/RX 100b, and the path connecting them is arbitrary. Information on the TX/RX 100a, the TX/RX 100b, and the path connecting them may be input to the control device 500 from a computer operated by an operator.

In Step S102, information on the path including the TX/RX 100a and 100b is collected. At least one of the TX/RX 100a and 100b outputs data on a bit error rate (BER) required for establishing communication and the environmental conditions of the optical receiver (RX) 110 to the control device 500 and the control device 500 receives environmental condition data. The BER required for communication establishment is an error rate generated in the DSP 130 and is a value such as 1×10⁻³ and this value is determined by the Forward Error Correction (FEC) capability used by the DSP 130. If the BER is this value or less, the DSP can correct it to a BER such as 1×10⁻¹² which is sufficient for communication establishment by error correction. BERₘᵢₙ in FIG. 4 indicates the error rate occurring in the DSP 130. The environmental condition data includes data about a dependence of a power supply voltage, a gain, a temperature, and a wavelength, and a thermal noise density of the TIA 112 and a shot noise density (frequency density) of the ITLA 113 converted on the basis of these with respect to a current. R_{pd} in FIG. 4 is the average photosensitivity of the PD included in the optical circuit 111 inside the RX 110, I_{eq} is a thermal noise density of the TIA 112, and these are examples of data relating to the RX 110 which is output from the TX/RX 100 to the control device 500. SNₜₓ(Iₒᵤₜ) in FIG. 4 is an SN ratio (current ratio) of the TX 120 itself and is an example of data relating to the TX 120 output from the TX/RX 100 to the control device 500. Furthermore, SNₐₛₑ in FIG. 4 is an SN ratio of an ASE noise generated by the EDFA 30 and is an example of data output from the EDFA 30 to the control device 500. The TX/RX 100 and the EDFA 30 provide the information necessary for the calculations which will be described below to the control device 500. When considering the dependence of the TX/RX 100 and the EDFA 30 with respect to the environmental condition in the calculation, the TX/RX 100 and the EDFA 30 provides the environmental condition dependence to the control device 500 as information necessary for the calculation.

In Step S103, the control device 500 calculates setting parameters for components of the RX 110a and 110b and the TX 120a and the TX 120b of the TX/RX 100a and 100b on the basis of data received from at least some of the TX/RX 100a and 100b and the EDFAs 30a and 30b. The determined setting parameters include setting parameters which satisfy the received BER from the TX/RX 100a and 100b and result in lower power consumption of the TX/RX 100a and 100b and the EDFAs 30a and 30b. The setting parameters may include EDFA 125 setting parameters.

In Step 104, the control device 500 provides the calculated setting parameters to the TX/RX 100a and 100b and the TX/RX 100a and 100b configure the RX 110 and the TX 120 on the basis of the provided setting parameters. The control device 500 also provides the calculated setting parameters to the EDFAs 30a, 30b, and 125 to configure the EDFAs 30a, 30b, and 125. Pₒᵤₜₜₓᵢₜₗₐ in FIG. 4 is a light intensity (local light intensity) output by the ITLA 123 in the TX 120, Iₒᵤₜ is an output current of the DRV 121 in the TX 120, and these are examples of data relating to the TX 120 transmitted from the control device 500 to the TX/RX 100. Pₒᵤₜᵣₓᵢₜₗₐ in FIG. 4 is a light intensity (local light intensity) output by the ITLA 113 in the RX 110 and is an example of data relating to the RX 110 transmitted from the control device 500 to the TX/RX 100. Furthermore, Gain in FIG. 4 is an example of data such as a current value associated with the amplification factor transmitted from the control device 500 to the EDFA 30. Steps S101 to S104 can be performed each time a path is changed or conditions change.

A more specific method of using noise information is as follows. In other words, in order to decode a signal with a bit error rate sufficient to establish communication in the DSP, a certain or higher SN ratio is required. Thus, each parameter of the TX/RX 100 need to be set so that an amount of noise is limited such that the SN ratio is a certain level or more.

As a coherent system noise, there are an ASE noise generated by an optical amplifier (for example, EDFA 30) on the transmission path, a thermal noise inside the TIA 112 of the optical receiver 110, a shot noise due to a photocurrent in the PD included in the optical circuit 111 which is noticeable in a coherent system using strong local light, and the like. In addition, the performance in which the optical transmitter 120 has in advance can also be represented by the SN ratio.

The signal amplitude Sₚₚ is obtained by multiplying a local light signal strength of the local light source 113 in the optical receiver 110, a signal light intensity and local light sensitivity of a photodetector such as a PD included in the optical circuit 111 inside the optical receiver 110, and signal light sensitivity.

$$\begin{matrix}Math . 1 & \\ {S}_{pp} = α * {R}^{2} * {P}_{LO} * {P}_{sig} & Expression ( 1 )\end{matrix}$$

Note that R is the average optical sensitivity of the optical receiver 110 (ratio of photocurrent to optical intensity), P_{LO} is a local light intensity, P_{sig} is a signal light intensity, and α is a constant which depends on the modulation format such as QPSK/QAM, a differential configuration of the optical receiver 110, and the like.

From this, since it is assumed that the noise is not extremely large, the additivity of the noise may be assumed and the signal-to-noise ratio (SNR) is expressed as follows.

$$\begin{matrix}Math . 2 & \\ {SNR}_{tot} = \frac{α * {R}^{2} * {P}_{LO} * {P}_{sig}}{{σ}_{TIA}^{2} + {σ}_{shot}^{2} + ( 1 / {SN}_{ASE} ) α * {R}^{2} * {P}_{LO} * {P}_{sig}} & Expression ( 2 )\end{matrix}$$

Note that, when a value of photosensitivity R differs between the local light (LO) side and the signal light (sig) side, R² can be R_{LO}×R_{sig} in both the denominator and numerator of Expression 2.

A thermal noise σ_{TIA} is described using a converted thermal noise density I_{eq} (in A/rtHz) at an input of the TIA 112 and a bandwidth f_{BWRX} of optical receiver 110 as follows.

$$\begin{matrix}Math . 3 & \\ {σ}_{TIA}^{2} = {I}_{eq}^{2} {f}_{BWRX} & Expression ( 3 )\end{matrix}$$

A shot noise σₛₕₒₜ is determined by the input current of the TIA 112 (the input current value I_{PD} from the photodiode (PD) included in the optical circuit 11) and is described as follows.

$$\begin{matrix}Math . 4 & \\ {σ}_{shot}^{2} = 2 {eI}_{PDave} {f}_{BWRX} & Expression ( 4 )\end{matrix}$$

e is an electron charge, I_{PDave} is a PD average photocurrent, and f_{BWRX} is a bandwidth of the optical receiver 110. In this band, when a common mode rejection ratio (CMRR) has an effect, this can also be added to calculate the SNR. it is represented by the following expression when a unit of measurement for the optical signal-to-noise ratio (OSNR) is dB/0.1 nm (for a wavelength of 1.55 μm, a wavelength shift of 0.1 nm corresponds to a shift of 12.5 GHz in frequency).

$$\begin{matrix}Math . 5 & \\ {SN}_{ASE} = {10}^{( \frac{OSNR}{10} )} * ( \frac{{f}_{BWRX}}{12.5 G} ) & Expression ( 5 )\end{matrix}$$

In this embodiment, the converted noise amount (thermal noise density) at the input section (TIA 112) of the RX 110 is used to eliminate an influence of the band of the amplifier (EDFA 30) or the like.

Furthermore, when the effects of imperfections in the optical transmitter 120 are treated in the same way as a noise and them are added assuming that the effects can be added independently, it may be performed as follows.

$$\frac{1}{{SN}_{ASE}} ⇒ \frac{1}{{SN}_{TX}} + \frac{1}{{SN}_{ASE}} \qquad Math . 6$$

SNₜₓ is a signal-to-noise ratio due to imperfections in the optical transmitter 120 itself.

Also, it is known that SN and BER can be converted by expressions corresponding to formats such as QPSK and mQAM. By using such expressions, it is possible to calculate the minimum required SN from the minimum communicable BER determined by the DSP 130.

Note that the information obtained from the optical transmitter/receiver 100 is a density with respect to a noise frequency (frequency is approximately 30 GHz in the case of a 64 Gbps electrical signal) and thus it is an amount obtained by multiplying it by a reception band f_{RX}. f_{BWRX} is largely determined by the transmission rate and is set by a digital filter inside the DSP 130 of the optical transmitter/receiver 100 (for example, in the case of a transmission rate of 64 Gbps, it is half that 32 GHz or more).

Note that, although the above expression uses the same value for f_{BWRX} for all types of noise, it is possible to use slightly different values for different types of noise depending on device measurement results.

Furthermore, the data of the noise amount of the receiver to be output and the SN ratio data of the transmitter or the like may be calculated by separately measuring the noise density characteristics and band characteristics of the device and stored in the control unit 131 or the like and may be output to the control device 500. Alternatively, in the data such as the noise amount of the receiver to be output and the data of the transmitter, the SN calculated from the result of the BER characteristic test of a part or all of the TX/RX 100 using the BER to SN conversion expression described above may be stored in the control unit 131 or the like and may be output to control device 500. Furthermore, when the SN to be set is set to a value larger than the minimum required SN with a certain margin, stable communication can be established even if the characteristics fluctuate more or less.

Setting parameters such as a current associated with a local light intensity of the local light source 113 of the RX 110, current values associated with amplification factors of the optical amplifiers 124 and 125 such as SOAs and EDFAs, and an output current of the modulator driver 121 of the TX 120 may be determined so that SNRₜₒₜ is a default value or less in which transmission in the assumed signal path is established and the overall power consumption is as low as possible.

If the initial SNRₜₒₜ is larger than a communication threshold limit SNRₜₕ by a certain amount, communication can basically be established even if each SN is degraded as long as the SNRₜₒₜ is larger than the limit value. From this expression, it is possible to calculate whether communication can be established even if the SN ratio is degraded to what extent. Thus, when Iₒᵤₜ is changed to degrade SNRₜₓ, it is possible to calculate whether communication can be established even if deterioration is caused to what extent. Therefore, it is possible to establish communication with a minimum Iₒᵤₜ. In this way, not only Iₒᵤₜ but also all the characteristics such as the gain of the amplifier in the path and the optical intensity of the ITLAs 113 and 123 of the optical transmitter/receiver 100 can be adjusted to minimize the power consumption. If a priority of reducing the power consumption of a particular component is high, it is possible to set the power consumption of that component to be preferentially reduced within the range in which communication can be established. In addition, it is also possible to perform setting under the worst conditions of possible fluctuation factors in the route currently set so that communication is always established within the expected fluctuation range if there is a fluctuation factor such as light intensity.

Also, SN may be calculated by adding a noise not described above. For example, in the case of the above-described optical transmitter (TX) and optical receiver (RX)-adjacently-disposed-optical transmitter/receiver integrated type optical transmitter/receiver 100, as data output from the control unit 131 to the control device 500, in addition to the dependence of a thermal noise density and a shot noise density with respect to a current, the dependence of TX 120 with respect to the output amplitude of the input-converted transmit-receive crosstalk noise in the TIA 112 caused by the TX 120 may be output. The control device 500 may set each parameter of the TX/RX 100 in consideration of input-converted transmission/reception crosstalk noise in the TIA 112 having the dependence of the TX 120 with respect to the output amplitude. Note that, although the communication path from the optical transmitter 120b on one side to the optical receiver 110a is explained with regard to the communication between the optical transmitter/receiver 100a and the optical transmitter/receiver 100b in FIG. 4, the control device 500 can similarly handle the communication path from the optical transmitter 120a on the opposite side to the optical receiver

### REFERENCE SIGNS LIST

10 Optical transmitter/receiver (TX/RX)
20 Switching device (OADM)
30 Amplifier (EDFA)
40 Optical fiber
50 Control device
100 Optical transmitter/receiver (TX/RX)
110 Optical receiver (RX)
111 Optical circuit (DPOH/PD)
112 Transimpedance amplifier (TIA)
113 Local light source (ITLA)
120 Optical transmitter (TX)
121 Modulator driver (DRV)
122 Optical Mach-Zehnder (MZ) modulator
123 Local light source (ITLA)
124 Optical amplifier (SOA)
125 Optical amplifier (EDFA)
130 Digital signal processor (DSP)
131 Control unit (CTRL)
500 Control device

1. An optical transmitter/receiver which transmits and receives an optical signal in which information is encoded in a phase and a light intensity, comprising:
an optical receiver having a light receiving element configured to receive the optical signal,
wherein a dependence of an amount of noise generated in the optical receiver in accordance with operating conditions of the optical receiver, photosensitivity of the light receiving element, and power consumption with respect to setting parameters is output to a control device of the optical transmitter/receiver.

2. The optical transmitter/receiver according to claim 1, wherein the operating conditions of the optical receiver include at least one of a power supply voltage, a gain, or a temperature, and
the amount of noise includes at least one of a thermal noise and a shot noise.

3. An optical transmitter/receiver which transmits and receives an optical signal in which information is encoded in a phase and a light intensity, comprising:
an optical transmitter having a modulator configured to generate the optical signal,
wherein an optical intensity according to a current input to the modulator, a signal-to-noise (SN) ratio of the optical transmitter, and the dependence of power consumption with respect to setting parameters are to a control device of the optical transmitter/receiver in accordance with operating conditions of the optical transmitter such as a power supply voltage, a gain, and a temperature.

4. A control device connected to an optical communication system which includes:
the optical transmitter/receiver according to claim 2,
an optical transmitter/receiver which transmits and receives an optical signal in which information is encoded in a phase and a light intensity, comprising:
an optical transmitter having a modulator configured to generate the optical signal,
wherein an optical intensity according to a current input to the modulator, a signal-to-noise (SN) ratio of the optical transmitter, and the dependence of power consumption with respect to setting parameters are to a control device of the optical transmitter/receiver in accordance with operating conditions of the optical transmitter such as a power supply voltage, a gain, and a temperature, and
a switching device to which the optical transmitters/receivers are connected and which dynamically switches paths between the optical transmitters/receivers, wherein
a dependence of the thermal noise generated in the optical receiver included in the optical transmitter/receiver, a transmission/reception crosstalk noise caused by the optical transmitter of the optical transmitter/receiver, power consumption with respect to setting parameters, and a dependence of the light intensity according to the current input to the modulator in the optical transmitter of the optical transmitter/receiver, the SN ratio of the optical transmitter, and power consumption with respect to the setting parameters are received, setting parameters of the optical transmitter/receiver are calculated, and
the calculated setting parameter is transmitted to the optical transmitter/receiver.
